(19) United States
(12) Patent Application Publication
(10) Pub. No.: US 2012/0240435 A1
(43) Pub. Date: Sep. 27, 2012

(54) METHODS FOR PATIENTS TO COMMUNICATE NON-VERBALLY WITH CAREGIVERS

(76) Inventor: Judith Meeks, Kelso, WA (US)

(21) Appl. No.: 13/069,126

(22) Filed: Mar. 22, 2011

(51) Int. Cl. G09F 3/00; G08B 13/14; G09B 21/00

(52) U.S. Cl. 40/586; 434/113; 340/572.1

(57) ABSTRACT

Methods for patients to communicate non-verbally with caregivers, including the steps of providing a communication device including a plurality of paddles and an organizing device, selecting a chosen message from the message set to communicate to a caregiver, selecting a selected paddle from the plurality of paddles corresponding to the chosen message, and communicating the message to a caregiver manipulating the selected paddle. Communication devices according to this disclosure include a support extending from a first end to a second end opposite the first end, a support opening proximate the first end of the support, and a banner member transversely mounted to the second end of the support, the banner member being configured to communicate a unique message, the plurality of unique messages on the plurality of paddles defining a message set. The organizing device is routed through the support opening of each paddle to moveably retain the plurality of paddles together.

### BACKGROUND

The present disclosure relates generally to methods for patients to communicate non-verbally with caregivers. In particular, this disclosure discuses using a collection of paddles to communicate unique messages related to medical care. There is a particular need for such devices in both medical and dental contexts, however this disclosure is not specifically limited to either of these particular contexts.

Known methods for communicating medical information are not entirely satisfactory for the range of applications in which they are employed. For example, existing methods often require verbal communication with an attendant or other person capable of relaying the message. Known methods often implement a verbal and/or telephonic means for relaying the message. However, these known methods require the use of verbal communication, which is often unavailable to a user requiring immediate attention. In particular, users with conditions that prevent them from speaking, users that are prevented from speaking due to the presence of dental equipment, and/or users that have been asphyxiated as a result of their condition may require immediate attention that they are unable to communicate verbally.

In addition, conventional methods for patients to communicate non-verbally with caregivers often imprecisely convey information. For example, hospitals and dentists often include a communication device that includes an option to call an attendant, but often such communication devices are unable to quickly communicate specific, targeted messages. In particular, such devices often require verbal communication to provide any clarification beyond a simple call to attention. Additionally, relying on gestures when an attendant is in close quarters with a patient may impossible based on the patient's condition or lead to contusion and inaction. Such inaction ay be critical, as it could occur at times when delay could result in serious harm to the patient.

Known methods for communicating medical and dental information non-verbally also often require the user to remain proximate the communication device during operation. For example, many hospitals implement a communication device near patients' bedsides that communicate a signal to a remote attendant when the patient requires assistance. However, these devices require the patient to remain bedside.

Thus, there exists a need for methods for patients to communicate non-verbally caregivers that improve upon and advance the design of known methods for communicating medical information non-verbally. Examples of new and useful methods for patients to communicate non-verbally with caregivers relevant to the needs existing in the field are discussed below.

### SUMMARY

The present disclosure is directed to methods for patients to communicate non-verbally with caregivers, including the steps of providing a communication device including a plurality of paddles and an organizing device, selecting a chosen message from he message set to communicate to a caregiver, selecting a selected paddle from the plurality of paddles corresponding to the chosen message, and communicating the message to a caregiver by manipulating the selected paddle. Communication devices according to this disclosure include a support extending from a first end to a second end opposite the first end, a support opening proximate the first end of the support, and a banner member transversely mounted to the second end of the support, the banner member being configured to communicate a unique message, the plurality of unique messages on the plurality of addles defining a message set. The organizing device is routed through the support opening of each paddle to moveably retain the plurality of paddles together.

Specifically, this disclosure relates to methods that implement the use of a collection of paddles including representations unique messages related to a particular medical condition. In particular, the paddles are retained in close proximity to another, allowing a user to select and display a paddle to are attendant or caregiver based on the message she would like to convey. In various embodiments, the paddles may implement color, text, symbols, Braille, or electromagnetic means for conveying the message, including radio frequency identification technologies. This disclosure is directed to methods for patients to communicate non-verbally with caregivers that communicate the information physically to a nearby caregiver or electronically to a remote or nearby attendant or caregiver.

### BRIEF DESCRIPTION OF THE DRAWINGS

FIG. 1 is a perspective view of a first example of a communication device.

FIG. 2 is a perspective view epic paddle of the communication device shown in FIG. 1.

FIG. 3 is a perspective view of a second example of a communication device, which includes an electronic communication element.

FIG. 4 is a perspective view of a third example of a communication device, which includes an electronic display element.

FIG. 5 is a flowchart depicting the steps of a method for patients to communicate non-verbally with caregivers.

### DETAILED DESCRIPTION

The disclosed methods for patients to communicate non-verbally with caregivers will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various methods for patients to communicate non-verbally with caregivers are provided. Related features in the examples may be identical, similar, or dissimilar in different examples. For the sake of brevity related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

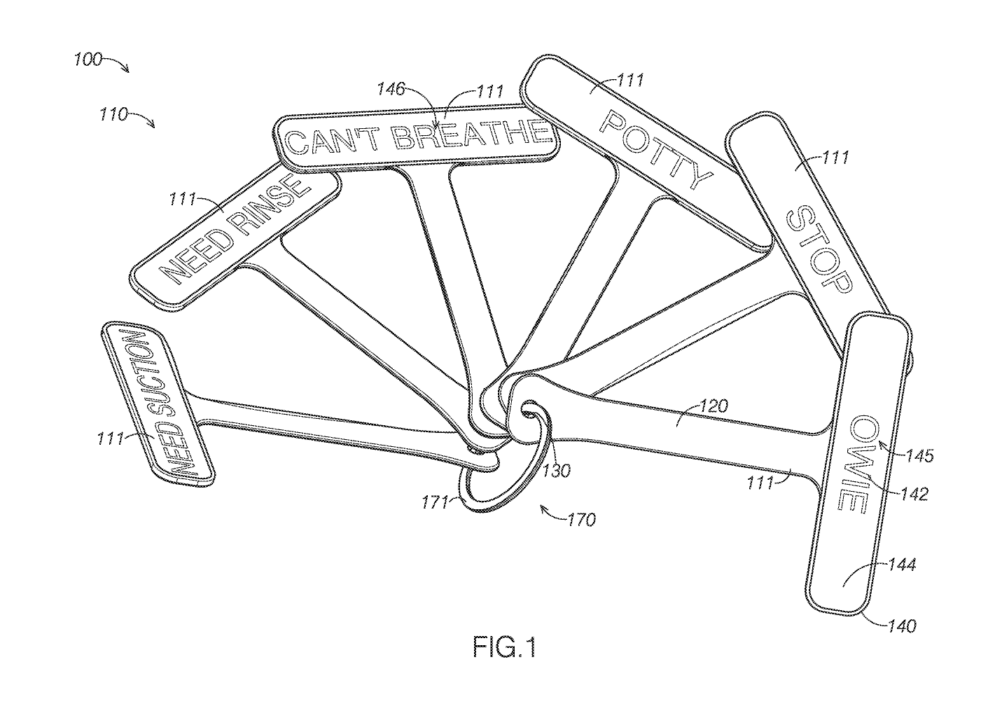

With reference to FIG. 1, a communication device 100 includes a plurality of paddles 110 and an organizing device 170. Communication device 100 includes a plurality of paddles 110 supported by organizing device 170 and is configured to allow a patient to select and display a selected paddle. 111 to a caregiver. Each paddle 111 is configured to convey a unique message to a caregiver when displayed. By displaying a particular paddle 111 to a caregiver, a patient is able to clearly convey information without speaking. This may include, for example, messages of pain or of medical need without the need for vocal interaction. This allows the caregiver to quickly interpret the message and respond to the patient's needs.

Communication device 100 and similar devices may be particularly suited to medical and dental contexts. Specifically, communication device 100 may be used by patients in dental contexts wherein the patient is unable to speak due to the presence of dental equipment in his or her mouth. Additionally, communication device 100 may be used in medical contexts when a user is unable to speak due to the presence speed limiting implements, devices, or equipment, when the patient is medicated to the point that they are unable to speak, or when the patient has become asphyxiated. Communication device 100 and other similar devices, however, are not specifically limited to these circumstances, and may be used in any patient and caregiver context where the patient's ability to speak may be compromised at some point.

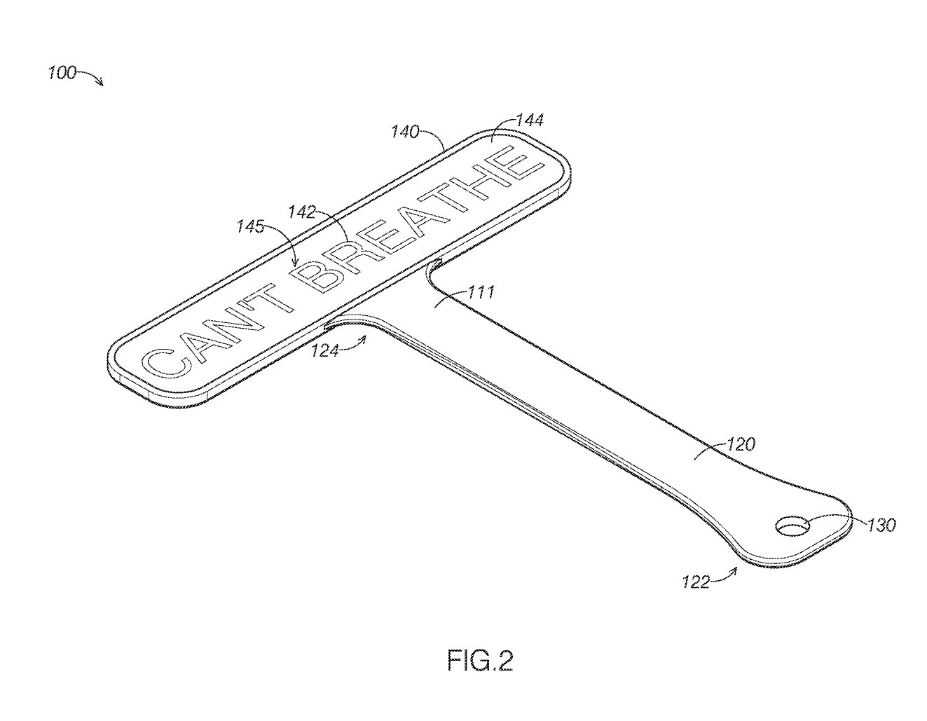

As illustrated in FIGS 1 and 2, each paddle 111 includes a support 120, a support opening 130, and a banner member 140. Each paddle 111 is configured to communicate a unique message by displaying text that correlates to the unique message on banner member 140. The collection of unique messages on each paddle 111 defines a message set.

As FIG. 2 illustrates, support 120 extends from a first end 122 to a second end 124 opposite first end 122. Each paddle 111 additionally includes a support opening 130 located substantially near the center of each support 120 proximate first end 122. Support opening 130 provides an opening on each paddle 111 through which organizing device 170 may be routed to retain each paddle 111.

Each paddle 111 is moveably supported on organizing device 170 by routing organizing device 170 through support opening 130. Support 120 spaces organizing device 170 from banner member 140. This spacing allows a patient to easily select and display an individual paddle 111 when plurality of paddles 110 is retained on organizing device 170.

As seen in FIGS. 1 and 2, each paddle 111 includes a banner member 140 transversely mounted to second end 124 of support 120. Banner member 140 includes a textual display 142 on a banner region 144. Each banner member 140 is configured to communicate a unique message from the patient to the caregiver. The unique messages displayed on each of the banner members of communication device 100 define the aforementioned message set.

Textual display 142 displays a textual message that correlates to banner member 140's unique message. The textual message is displayed laterally across banner member 140. Certain paddles 111 include a textual display 142 that includes a textual display code 145 that correlates to the specific message that the patient would like to convey. For example, FIG. 1 illustrates textual display code 145 “OWIE” to convey that a patient is in physical pain. However, other paddles 111 include a textual display that includes an exact textual representation 146 of the message being conveyed. For example, FIG. 1 illustrates exact textual representation 146 that includes the term “CAN'T BREATHE” to indicate that the patient can't breathe.

Although FIGS. 1 and 2 are black and white representations of communication device 100 and an individual paddle 111, certain paddles 111 additionally include a color on all or a portion of its surface area to communicate paddle 111's unique message. For example, the paddle that correlates to a message of physical pain includes a substantially red color on its surface area. The paddle that includes the coded message “POTTY,” conveying that a user needs to use the restroom, includes a substantially yellow color on its surface.

As FIG. 1 illustrates, organizing device 170 includes 171 routed through the support: openings of plurality of paddles 110. Fastener 171 defines a ring sized to retain plurality of paddles 110 in close proximity to another while allowing a patient to manipulate the paddles. Fastener 171 allows each paddle 111 to be moved around the perimeter of the ring and allows each paddle to be rotated around an axis defined by the segment of fastener 171 routed through support opening 130. Fastener 171 is configured to open to allow a patient or caregiver to add or remove paddles.

Communication device 100 is configured for a patient to convey a unique message non-verbally by manipulating a selected paddle to display the banner member 140 to a caregiver. Specifically, a patient manipulates the selected paddle 111 by gripping the selected paddle and moving either the selected paddle or the non-selected paddles until the banner member of the selected paddle is distinctly displayed relative the remainder of the banner members. For example, the patient can rotate a selected paddle 111 around fastener 171 to separate paddle 111 from the remainder of plurality of paddles 110. As another example, the patient can rotate the selected paddle around fastener 171 until the banner member of the selected paddle is misaligned with, and thus visible around, the other banner members.

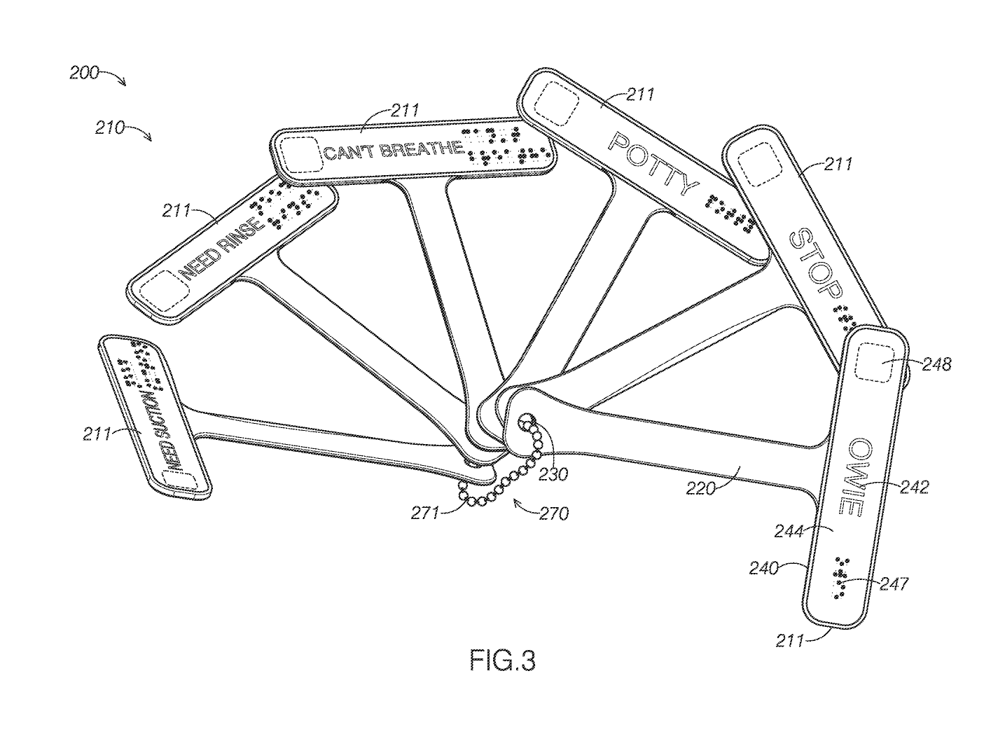

Turning attention to FIG. 3, a second example of a communication device, communication device 200, will now be described. Communication device 200 includes many similar or identical features to communication device 100 combined in unique and distinct ways. Thus, for the sake of brevity, each feature of communication device 200 will not be redundantly explained. Rather, key distinctions between communication device 100 and communication device 200 will be described in detail and the reader should reference the discussion above for features substantially similar between the two communication devices.

With reference to FIG. 3, a communication device 200 includes a plurality of paddles 210 and an organizing device 270, similar to communication device 100. Although the general organization of communication device 200 is similar to communication device 100, plurality of paddles 210 includes additional features compared to plurality of paddles 110. Additionally, organizing device 270 includes a fastener 271 different to that of organizing device 170.

As shown in FIG. 3, plurality of paddles 210 includes a collection of individual paddles 211, each similar to the individual paddles 111 included in plurality of paddles 110. Similar to each paddle 111, each paddle 211 includes a support 220 and a support opening 230.

Additionally, each paddle 211 includes a banner member 240 transversely mounted to support 220 and configured to communicate a unique message. Each banner member 240 includes a textual display 242 and a banner region 244 similar to textual displays 142 and banner regions 144, respectively. Textual display 242 projects from the surface of banner member 240, providing the patient and/or caregiver with a first relieved representation of the message that can be detected by touch. Each banner member 240 additionally includes a collection of raised dots 247 and a radio frequency identification tag 248.

Collection of raised dots 247 is proximate textual display 242 and conveys the unique message in Braille. This provides the patient and caregiver with a second relieved representation of each paddle 211's unique message that can be interpreted by touch. Interpreting the message by touch allows a visually impaired patient to identify and select a paddle that corresponds to the unique message she would like to convey. Additionally, collection of raised dots 247 provide a caretaker an alternative means of interpreting the unique message to reading textual display 242.

Radio frequency identification tag 248 is positioned on the interior of each paddle 211, substantially within banner member 240. Radio frequency identification tag 248 is configured to couple external radio frequency identification reader and transmitter to communicate the banner member's unique message. Radio frequency identification tag 248 is configured to modulate a signal received from radio frequency identification reader and transmitter and subsequently send the modulated signal to the radio frequency identification reader and transmitter. The radio frequency identification reader and transmitter is configured to translate the modulated signal to interpret the patients unique message.

Once the radio frequency identification reader and transmitter receives the modulated signal it may transmit this information electronically to other locations through computer network protocols including WiFi, audio transmission protocols, video transmission protocols, or other means of electronic communication. For example, radio frequency identification reader and transmitter may be connected to digital networks within the hospital, and unique messages may be conveyed over these digital networks. This allows caregivers great flexibility in responding to unique messages. Caregivers may monitor unique messages remotely and may develop systems wherein automated processes are instituted based on patients' unique messages.

Unlike several existing systems for conveying messages of medical need electronically, the system disclosed herein allows users to non-verbally communicate messages of need to remote caregivers in a more targeted and specific manner. For example, communication device 200 includes paddies 211 that are each configured to electronically communicate a unique message tailored specifically to the patient's condition, wherein the communicated unique message may be distributed to electrically connected remote locations. Many similar existing systems include only a single “call” button, only configured to indicates that the patient needs assistance. Because communication device 200 is configured to more clearly communicate patients' requests, it allows caregivers to provide more efficient service and substantially prevent or reduce harm to the patient that results from an inability to properly communicate the patient's need in a timely manner.

Similar to communication device 100, communication device 200 includes an organizing device 270 including fastener 271 routed through each support opening 230. Unlike fastener 171, fastener 271 defines a small link metal chain 272. Manipulating plurality of paddles 210 relative organizing device 270 is achieved in a substantially similar manner to that seen in communication device 100. That is, a patient manipulates plurality of paddles 210 around organizing device 270 by manually gripping and maneuvering a selected paddle around fastener 271. Chain 272 has less rigidity compared to fastener 171, which provides more freedom of movement when selecting a paddle. For example, when a patient retains a selected paddle, chain 272's flexibility allows the non-selected paddles to fall below the selected paddle.

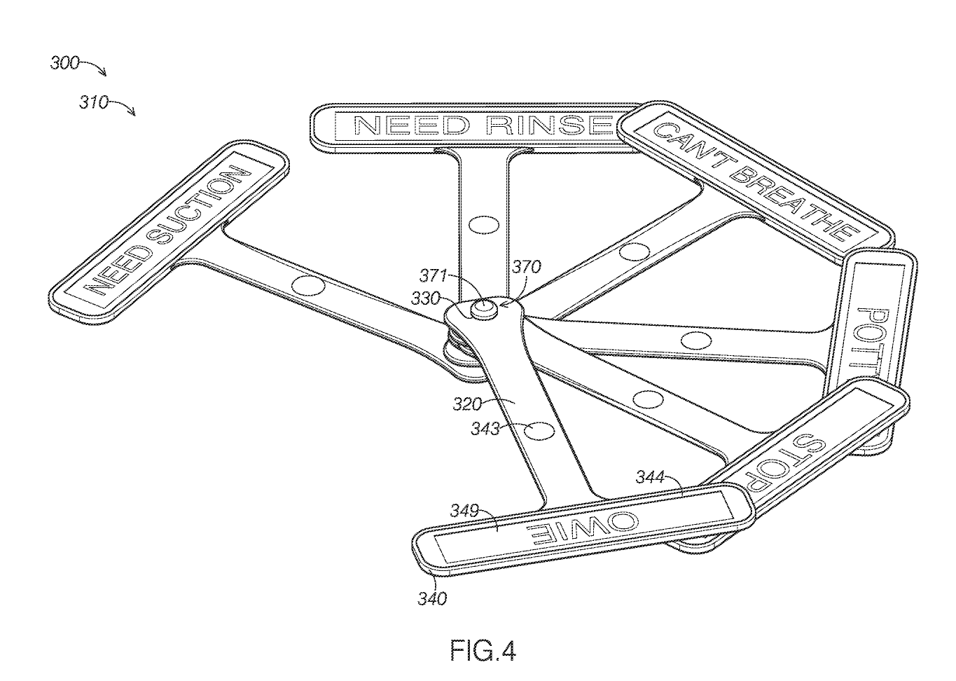

Turning attention to FIG. 4, a third example of a communication device, communication device 300, will now be described. Communication device 300 includes many similar or identical features to communication device 100 combined in unique and distinct ways. Thus, for the sake of brevity, each feature of communication device 300 will not be redundantly explained. Rather, key distinctions between communication device 100 and communication device 300 will be described in detail and the reader should reference the discussion above for features substantially similar between the two communication devices.

With reference to FIG. 4, a communication device 300 includes a plurality of paddles 310 and an organizing device 370. Although the general organization of communication device 300 is similar to that of communication device 100, communication device 300 includes paddles 311 with features different to those seen in plurality of paddles 110. Organizing device 370 also includes a different type of paddle retainer than organizing device 170.

Plurality of paddles 310 is mostly similar to plurality of paddles 110, including a support 320, a support opening 330, and a banner member 340. Similar to banner member 140, banner member 340 includes a banner region 344. However, unlike banner member 240, banner member 340 includes an electronic display 349. Each paddle 311 additionally includes an electronic display activator 343 positioned on support 320. Paddles 310 may be manipulated to show the display by gripping the support, displaying the banner member, and pressing the electronic display activator 343.

Electronic display 349 allows for a backlit electronic display. This allow communication device 300 to properly convey unique messages in dark or dimly lit contexts. Additionally, electronic display 349 allow each paddle 311's unique message to be electronically modified at a software level subsequent to the fabrication of the device. This disclosure specifically contemplates he use of USB and/or other digital communication interfaces to modify the unique message electronically.

Additionally, organizing device 370 includes a fastener 371 that defines a plastic rivet to retain plurality of paddles 310 proximate one another. Fastener 371 is routed through each paddle 311's support opening 330 to retain plurality of paddies 310 closely engaged with each other. Specifically, fastener 371 retains each paddle 311 in a substantially fixed position absent any external force. A patient can manipulate a selected paddle by rotating the selected paddle around fastener 371's rivet. This causes the selected paddle's banner member to become misaligned with the remainder of the plurality of paddles 310.

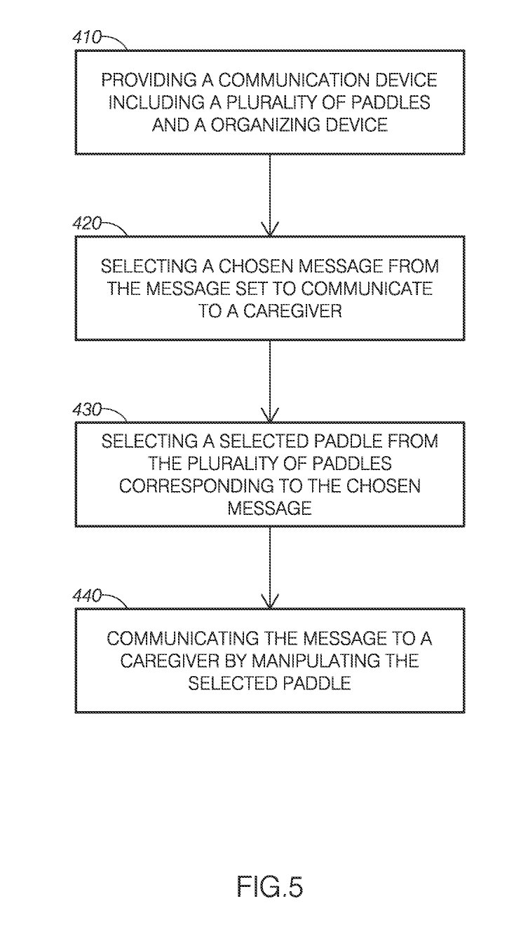

Turning attention to FIG. 5, a method 400 for a patient to communicate non-verbally with a caregiver will now be described. Method 400 includes the steps of providing a communication device including a plurality of paddles and an organizing device 410, selecting a chosen message from the message set to communicate to a caregiver 420, selecting a selected paddle from the plurality of paddles corresponding to the chosen message 430, communicating the message to a caregiver by manipulating the selected paddle 440.

The first step of method 400 is providing a communication device including a plurality of paddles and an organizing device 410. During this step, a patient is provided with a device consistent with those disclosed herein, such as communication device 100, communication device 200, or communication device 300.

The second step of method 400 is selecting a chosen message from the message set to communicate to a caregiver 420. A patient considers the entirety of messages included in the message set and determines the unique message that best communicates his present need. In many cases, the unique messages available on a patient's communication device may not fully describe his need. In such a situation, the patient may select the unique message that most strongly correlates to his need, and present that message to the caregiver. Additionally, the patient may supplement the unique message with verbal cues or non-verbal gestures. This disclosure also specifically contemplates selecting chosen messages that include multiple unique messages or combining messages from multiple paddles or combining messages from multiple paddles.

The third step of method 400 is selecting a selected paddle from the plurality of paddles corresponding to the chosen message 430. At this stage the patient selects the paddle that correlates to the unique message most similar to the patient's chosen message.

The fourth step of method 400 is communicating the message to a caregiver by manipulating the selected paddle 440. In many cases, this step will involve manipulating the selected paddle in the manner discussed above in conjunction with the communication devices. For example, for paddles that include physical displays, such as those that implement textual displays and colors, the selected paddle is physically distinguished by the patient in some manner, such as by holding it up, pointing to it, or waving it.

For paddles that include raised features, such as Braille dots or a raised textual display, step 440 may involve physically placing the selected paddle in a caregiver's possession. For paddles with electronic displays, step 440 may additionally or alternatively involve activating the electronic display. When using paddles implementing a radio frequency identification tag, step 440 may involve positioning the selected paddle proximate a radio frequency identification reader and transmitter.

Although this disclosure discusses several specific methods of communicating the message, any method of specifically pointing a caregiver to the selected paddle, including supplementing the non-verbal communication with verbal and/or audible cues, is equally within this disclosure.

The disclosure above encompasses multiple distinct inventions with independent utility. While each of these inventions has been disclosed in a particular form the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A method for a patient to communicate non-verbally with a caregiver-, the method comprising:
(a) Providing a communication device including a plurality of paddles and an organizing device, the plurality of paddles each including:
a support extending from a first end to a second end opposite the first end;
a support opening proximate the first end of the support; and
a banner member configured to communicate a unique message and including a color selected to assist with communicating the unique message to a caregiver, the plurality of unique messages on the plurality of paddles defining a message set;
wherein the organizing device is routed through the support opening of each paddle to moveably retain the plurality of paddles together;
(b) selecting a chosen message from the message set to communicate to a caregiver;
(c) selecting a selected paddle from the plurality of paddles corresponding to the chosen message; and
(d) communicating the message to a caregiver by manipulating the selected paddle.

2. The method of claim 1, wherein manipulating the selected paddle includes displaying the banner member to the caregiver.

3. The method of claim 2, wherein the banner member includes a textual display displaying a textual message.

4. The method of claim 3, wherein the textual message includes an explicit recital of the unique message.

5. The method of claim 3, wherein the textual message includes a code selected to convey the unique message.

6. The method of claim 1, wherein the banner member includes an electronic display and manipulating the selected paddle includes activating the electronic display.

7. The method of claim 1, wherein the banner member includes a radio frequency identification tag and manipulating the selected paddle includes bringing the radio frequency identification tag within reading proximity of a radio frequency identification tag reader.

8. The method of claim 1, wherein the banner member includes a collection of raised dots corresponding to a message in Braille.

9. The method of claim 1, wherein the banner member includes a banner region and the banner region defines the entire surface area of the banner member.

10. (canceled)

11. The method of claim 1, wherein a first banner member is green and communicates a message of good health.

12. The method of claim 1, wherein a first banner member is red and communicates a message of pain.

13. The method of claim 1, wherein a first banner member is yellow and communicates a message of requiring urination.

14. The method of claim 1, wherein the organizing device includes a ring and selecting a selected paddle includes moving non-selected paddles around the ring away from the selected paddle.

15. The method of claim 1, wherein the organizing device includes a chain and selecting a selected paddle includes moving non-selected paddles around the chain away from the selected paddle.

16. The method of claim 1, wherein the organizing device includes a rivet and selecting a selected paddle includes rotating the selected paddle away from the misaligned paddles around the rivet.

17. The method of claim 1, wherein the organizing device retains the plurality of paddles in a substantially fixed position closely engaged with each other, until the patient imparts a force on a selected paddle.

18. (canceled)

19. (canceled)

20. (canceled)

21. The method of claim 1, wherein the color is selected to communicate a need of the patient to the caregiver.

22. A method for a patient to communicate non-verbally with a caregiver, the method comprising:
(a) providing a communication device including a plurality o paddles and an organizing device, the plurality of paddles, each including:
a support extending from a first end to a second end opposite the first end;
a support opening proximate the first end of the support; and
a banner member transversely mounted to the second end of the support, the banner member being configured to communicate a unique message, the plurality of unique messages on the plurality of paddles defining a message set;
wherein the organizing device is routed through the support opening of each paddle to moveably retain the plurality of paddles together;
(b) selecting a chosen message from the message set to communicate to a caregiver;
(c) selecting a selected paddle from the plurality of paddles corresponding to the chosen message; and
(d) communicating the message to a caregiver by manipulating the selected paddle;
wherein the banner member includes an electronic display and manipulating the selected paddle includes activating the electronic display.

23. A method for a patient to communicate non-verbally with a caregiver, the method comprising:
(a) providing a communication device including a plurality of paddles and an organizing device, the plurality of paddles, each including:
a support extending from a first end to a second end opposite the first end;
a support opening proximate the first end of the support; and
a banner member transversely mounted to the second end of the support, the banner member being configured to communicate a unique message, the plurality of unique messages on the plurality of paddles defining a message set;
wherein the organizing device is routed through the support opening of each paddle to moveably retain the plurality of paddles together;
(b) selecting a chosen message from the message set to communicate to a caregiver;
(c) selecting a selected paddle from the plurality of paddles corresponding to the chosen message; and
(d) communicating the message to a caregiver by manipulating the selected paddle;
wherein the banner member includes a radio frequency identification tag and manipulating the selected paddle includes bringing the radio frequency identification tag within reading proximity of a radio frequency identification tag reader.

24. A method for a patient to communicate non-verbally with a caregiver, the method comprising:
(a) providing a communication device including a plurality of paddles and an organizing device, the plurality of paddles, each including:
a support extending from a first end to a second end opposite the first end;
a support opening proximate the first end of the support; and
a banner member transversely mounted to the second end of the support, the banner member being configured to communicate a unique message, the plurality of unique messages on the plurality of paddles defining a message set;
wherein the organizing device is routed through the support opening of each paddle to moveably retain the plurality of paddles together;
(b) selecting a chosen message from the message set to communicate to a caregiver;
(c) selecting a selected paddle from the plurality of paddles corresponding to the chosen message; and
(d) communicating the message to a caregiver by manipulating the selected paddle;
wherein the banner member includes a collection of raised dots corresponding to a message in Braille.
